(19) United States
(12) Patent Application Publication
(10) Pub. No.: US 2013/0187898 A1
(43) Pub. Date: Jul. 25, 2013

(54) Non-Volatile Type Display Apparatus and Damage Detection Method Thereof

(71) Applicant: PERVASIVE DISPLAYS INC., Tainan City (TW)

(72) Inventors: Hsin-Ta LEE, Tainan City (TW); Chi-Lin PAI, Tainan City (TW); Chien-Chung LEE, Tainan City (TW)

(73) Assignee: PERVASIVE DISPLAYS INC., Tainan City (TW)

(21) Appl. No.: 13/744,554

(22) Filed: Jan. 18, 2013

(30) Foreign Application Priority Data
Jan. 20, 2012 (TW) 101102693
Dec. 3, 2012 (TW) 101145349

(51) Int. Cl. G09G 5/00

(52) U.S. Cl. CPC G09G 5/003
USPC 345/204

(57) ABSTRACT

A non-volatile type display apparatus includes a control unit and a display unit electrically connected to the control unit. The control unit ascertains whether the display unit is damaged or not according to an ascertainment signal. A damage detection method for the non-volatile type display apparatus is also disclosed.

### CROSS REFERENCE TO RELATED APPLICATIONS

This Non-provisional application claims priority under 35 U.S.C. §119(a) on Patent Application No(s). 101145349 and 101102693 filed in Taiwan, Republic of China on Dec. 3, 2012 and Jan. 20, 2012, respectively, the entire contents of which are hereby incorporated by reference.

### BACKGROUND OF THE INVENTION

1. Field of Invention

The invention relates to a non-volatile type display apparatus and a damage detection method thereof.

2. Related Art

With the advance of display technology, various display apparatuses are widely applied in the present age. Especially, the non-volatile type display apparatus, such as an electronic paper (e-paper) display, has been widely applied to the products like electronic tags, electronic books, or digital photo frames for the sake of the advantage of less power consumption. For the electronic tag, it has been used to replace the old sticker tag in shops or markets, showing product information, e.g. product name, price or discount, etc. In addition to saving the cost, using the electronic tag also can facilitate environment protection and the centralized management of products.

When the electronic tag is damaged, the content displayed by the electronic tag can not be renewed. However, because the non-volatile type display apparatus has bistable characteristics, it still displays information. Hence, the electronic tag may show the uncorrected and incorrect product information. For a shop's manager, it must not be permitted, and instead, the manager needs to find out the problem prior to customers for carrying out the repair or the replacement. Or, customers may not be pleased, and thus loss their purchase intension and the trust in the shop.

Therefore, it is an important subject to provide a non-volatile type display apparatus and a damage detection method thereof that can effectively ascertain whether the non-volatile type display apparatus is damaged or not, and then the ascertainment result is transmitted to the manager to allow the manager to know the non-volatile type display apparatus has been damaged as soon as possible for the repair or the replacement.

### SUMMARY OF THE INVENTION

In view of the foregoing subject, an objective of the invention is to provide a non-volatile type display apparatus and a damage detection method thereof that can effectively ascertain whether the non-volatile type display apparatus is damaged or not, and then the ascertainment result is transmitted to the manager to allow the manager to know the non-volatile type display apparatus has been damaged as soon as possible for the repair or the replacement.

To achieve the above objective, a non-volatile type display apparatus according to the invention includes a control unit and a display unit. The display unit is electrically connected to the control unit. The control unit ascertains whether the display unit is damaged or not according to an ascertainment signal.

In one embodiment, the non-volatile type display apparatus is cooperated with an external electronic apparatus and further includes a communication unit coupled to the external electronic apparatus and the control unit. The communication unit receives an inquiry signal outputted by the external electronic apparatus and outputs the ascertainment signal to the control unit according to the inquiry signal.

In one embodiment, the communication unit and the external electronic apparatus are coupled by a wired method or a wireless method.

In one embodiment, the control unit includes a sensor, which senses temperature, electric energy, vibration, or their any combination,

In one embodiment, the ascertainment signal is a periodic signal generated by the control unit, and the control unit outputs a detection signal, according to the ascertainment signal, to the display unit to ascertain whether the display unit is damaged.

In one embodiment, the display unit further includes at least a conductive body, which is disposed around or inside a display area of the display unit and electrically connected to the control unit.

In one embodiment, the control unit outputs a detection signal to the conductive body, and ascertains if the display unit is damaged according to whether the detection signal is returned or not.

In one embodiment, the conductive body is a conductive wire disposed into a single strand or a plurality of strands.

In one embodiment, the conductive body has a linear, “L”, “U”, or “O” shape.

In one embodiment, the total length of the conductive body is larger than or equal to three fourths of the perimeter of a display area of the non-volatile type display apparatus.

In one embodiment, the control unit includes a plurality of integrated circuits, and the conductive body is connected to the integrated circuits.

In one embodiment, the display unit further includes a driving substrate, and the control unit is disposed on at least one of the driving substrate and a circuit board.

In one embodiment, the circuit board is disposed adjacent to the driving substrate.

To achieve above objective, a damage detection method of a non-volatile type display apparatus is cooperated with a non-volatile type display apparatus coupled to an external electronic apparatus, and includes steps of: receiving an inquiry signal outputted by the external electronic apparatus; and ascertaining whether a display unit of the non-volatile type display apparatus is damaged or not.

In one embodiment, the non-volatile type display apparatus further includes a communication unit and a control unit. The communication unit, the control unit and the display unit are electrically connected to each other. When receiving the inquiry signal, the communication unit outputs an ascertainment signal to the control unit, and the control unit ascertains whether the display unit is damaged according to the ascertainment signal.

In one embodiment, ascertaining whether the display unit is damaged is performed several times consecutively, and if the ascertainment result indicates the damage at least one time, the display unit is ascertained as damaged.

In one embodiment, the inquiry signal outputted by the external electronic apparatus is generated by an operator operating the external electronic apparatus or self-generated by the external electronic apparatus.

In one embodiment, the damage detection method further comprises a step of: transmitting an ascertainment result to the external electronic apparatus.

In one embodiment, the control unit outputs a detection signal to a conductive body of the display unit disposed around or inside a display area of the display unit, and ascertains if the display unit is damaged according to whether the detection signal is returned or not.

In one embodiment, when the temperature, electric energy, vibration or their any combination of the non-volatile type display apparatus is abnormal, the external electronic apparatus outputs the inquiry signal.

As mentioned above, for the non-volatile type display apparatus and the damage detection method thereof according to the invention, when the external electronic apparatus queries the damage condition of the non-volatile type display apparatus, the display unit's condition cab be ascertained by the cooperation of the communication unit and the control unit, and then the ascertainment result can be transmitted to the manager so that the manager can find out the non-volatile type display apparatus has been damaged as soon as possible for the repair or the replacement.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a block diagram of a non-volatile type display apparatus according to a preferred embodiment of the invention;

FIG. 2A is a schematic top view of a non-volatile type display apparatus according to a preferred embodiment of the invention;

FIG. 2B is a sectional diagram of the non-volatile type display apparatus taken along the line A-A in FIG. 2A;

FIGS. 3A to 3G are schematic diagrams of varieties of the non-volatile type display apparatus according to a preferred embodiment of the invention; and

FIG. 4 is a flow chart of a damage detection method of a non-volatile type display apparatus according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

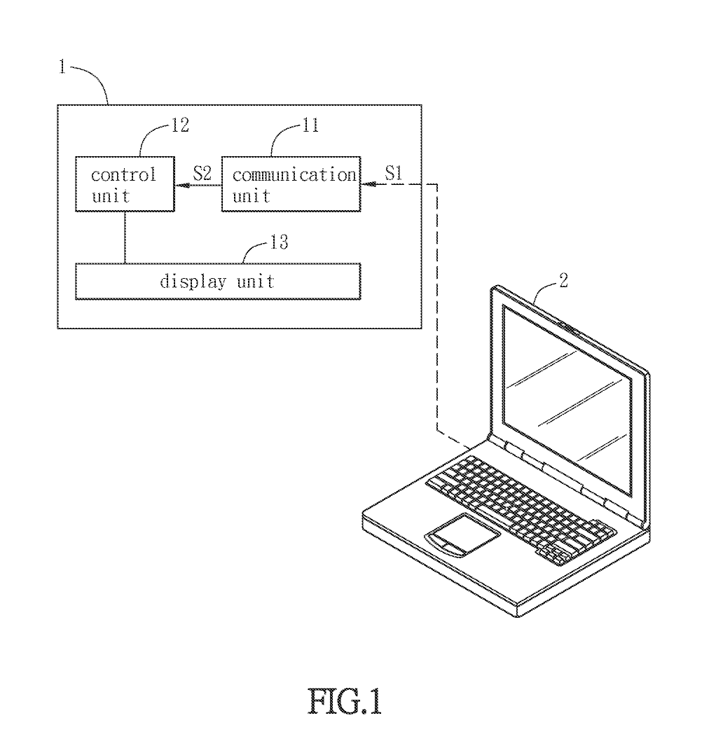

FIG. 1 is a block diagram of a non-volatile type display apparatus according to a preferred embodiment of the invention. In FIG. 1, the non-volatile type display apparatus 1 includes a control unit 12 and a display unit 13. The non-volatile type display apparatus 1 is a bistable display apparatus, such as an electronic paper (e-paper). The e-paper can be of an electrophoretic display type or of a cholesteric liquid crystal display type. Furthermore, an e-paper of the electrophoretic display type can be made by the microencapsulated electronic ink technology, the microcup technology, or the quick response liquid powder display (QR-LPD) technology, for example.

The non-volatile type display apparatus 1 is cooperated with an external electronic apparatus 2, which can be a computer or a server for example. As an embodiment, the external electronic apparatus 2 is a computer operated by a shop's manager, a plurality of non-volatile type display apparatuses 1 are used as the electronic tags for showing the products' information, and the manger can manage the products' information shown by the electronic tags through the computer.

The communication unit 11 is coupled to the external electronic apparatus 2 by a wired method (e.g. cables), a wireless method (e.g. wireless network), or their combination. No matter how they are coupled to each other, the function of the communication unit 11 is to communicate with the external electronic apparatus 2 for exchanging the information, and thus the communication unit 11 can receive the signal of the external electronic apparatus 2 or transmit the signal to the external electronic apparatus 2. Any means that can achieve the above operation should belong to the scope of this invention. In this embodiment, the communication unit 11 receives an inquiry signal S1 and transmits an ascertainment signal S2 according to the inquiry signal S1.

The control unit 12 is electrically connected to the communication unit 11, and can be a control chip for example, to receive the ascertainment signal S2 for the operation coming after. In other embodiments, the communication unit 11 and the control unit 12 can be integrated together, in consideration of the process or practical requirements, to become a multi-functional chip possessing the functions of the communication unit 11 and the control unit 12. However, the invention is not limited thereto.

The display unit 13 is electrically connected to the control unit 12, and can be a unit of the non-volatile type display apparatus 1 for displaying images. For the e-paper as an example, the display unit 13 can includes a panel of an electrophoretic display type or of a cholesteric liquid crystal display type. However, the invention is not limited thereto.

In this embodiment, the control unit 12 ascertains whether the display unit 13 is damaged or not according to an ascertainment signal S2. The ascertainment signal S2 can be self-generated by the control unit 12 or the signal transmitted to the control unit 12 from the external electronic apparatus 2. Herein for example, the non-volatile type display apparatus 1 is cooperated with the external electronic apparatus 2 and receives the signal (leading to the ascertainment signal S2) from the external electronic apparatus 2 to ascertain whether the display unit 13 is damaged or not, and thus transmits an ascertainment result to the external electronic apparatus 2 through the communication unit 11. For an example wherein the external electronic apparatus 2 is a computer operated by a shop's manager and the non-volatile type display apparatus 1 is an electronic tag for showing the product's information, the manager can effectively know the failure condition of the electronic tag by the ascertainment result so as to conduct the repair or the replacement as soon as possible. Thereby, the electronic tag is prevented from showing incorrect information, and therefore the customer's trust in the shop will not be decreased.

For helping the manager easily perceive which of the non-volatile type display apparatuses 1 is damaged, the non-volatile type display apparatus 1 can further include an indication unit, which can be electrically connected to the control unit 12. The indication unit can be a unit capable of emitting sounds or light to make the manager perceive whether the non-volatile type display apparatus 1 is damaged or not. For the indication unit capable of emitting sounds, when the non-volatile type display apparatus 1 is damaged, it emits sounds to the manager or a detector. For the indication unit capable of emitting light, when the non-volatile type display apparatus 1 is damaged, it can emit, for example, red light (while green light in the normal case) that is easily perceived by the manager.

In other embodiments, the ascertainment signal S2 can be a self-generated signal of the control unit 12, such as an ascertainment signal occurring periodically. The control unit 12 outputs a detection signal to the display unit 13 according to the ascertainment signal S2, and ascertains if the display unit 13 is damaged according to whether the detection signal is returned or not. In this case, the control unit 12 doesn't need to wait for the ascertainment signal outputted by the communication unit 11. As an embodiment, the control unit 12 can output a detection signal to the display unit 13 periodically for the periodic detection. Furthermore, if the control unit 12 receives the detection signal returned by the display unit 13, the display unit 13 is ascertained as undamaged. Conversely, if the control unit 12 doesn't receive the detection signal returned by the display unit 13, the display unit 13 is ascertained as damaged.

Besides, the control unit 12 can include a sensor, which can sense temperature, electric energy, vibration, or their any combination, and the abnormal condition about the temperature, electric energy or vibration can be detected according to the sensing result of the sensor. When the abnormal condition occurs, the detection signal can be outputted to the display unit 13 for ascertaining whether the display unit 13 is damaged.

In this embodiment, the display unit 13 can include at least a conductive body (such as a conductive wire or a conductive pattern). The conductive body is disposed around or inside the display area (and can be disposed on the top substrate or the bottom substrate of the display unit 13), and electrically connected to the control unit 12. The control unit 12 can output the detection signal to the conductive body, and then ascertain if the display unit 13 is damaged according to the return condition of the detection signal. When the conductive body is disposed on the inside of the display area of the display unit 13, the conductive body can be disposed on the substrate where the interior circuit of the display unit 13 (such as scan lines, data lines, etc.) is disposed but at different layer from the interior circuit, or the conductive body can be disposed on the other substrate but located on the inside of the display area in a projection direction. If the control unit 12 receives the detection signal returned by the display unit 13, the display unit 13 is ascertained as undamaged. Conversely, if the control unit 12 doesn't receive the detection signal returned by the display unit 13, the display unit 13 is ascertained as damaged.

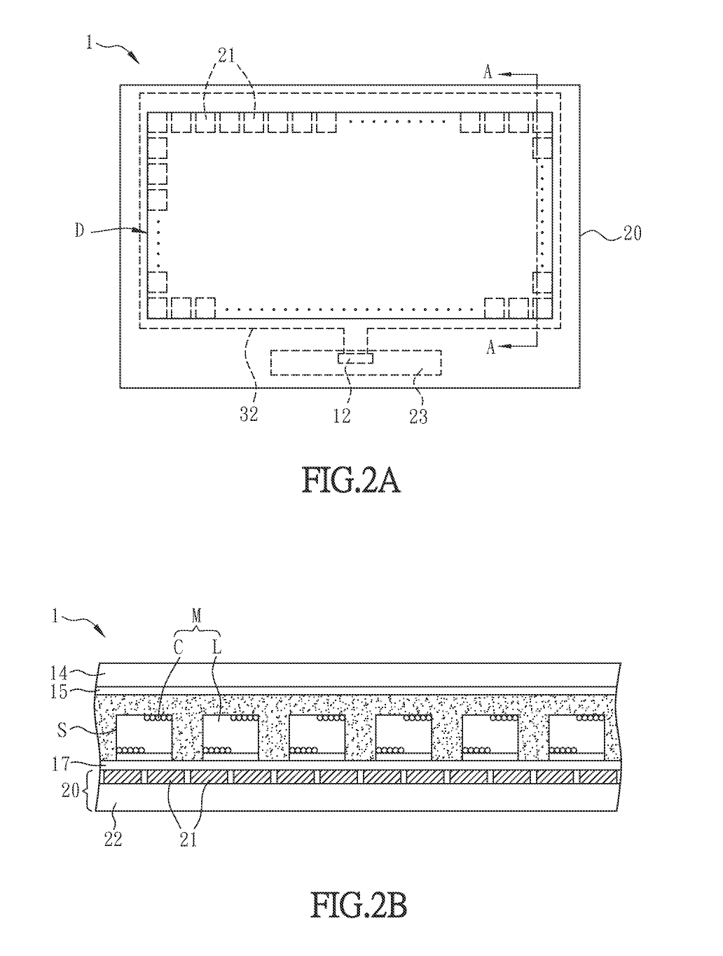

FIG. 2A is a schematic top view of a non-volatile type display apparatus 1 according to a preferred embodiment of the invention, and FIG. 2B is a sectional diagram of the non-volatile type display apparatus 1 taken along the line A-A in FIG. 2A. The structure of the non-volatile type display apparatus 1 is further illustrated as below by referring to FIGS. 2A and 2B.

The non-volatile type display apparatus 1 has a display area D. The display unit 13 includes a non-volatile type display material M and a driving substrate 20.

The driving substrate 20 has a plurality of pixel electrodes 21 and a bottom substrate 22, and the pixel electrodes 21 are disposed on the bottom substrate 22. The material of the bottom substrate 22 can be resin, ceramic material, or glass. A control circuit (such as a control chip or a control circuit board) 23 is disposed on the bottom substrate 22, and drives the non-volatile type display material M through the pixel electrodes 21 for displaying images. The driving substrate 20 can use the active matrix driving or the passive matrix driving, and herein for example, it uses the active matrix driving.

The non-volatile type display material M is disposed on a side of the driving substrate 20, and can include electrophoretic material, rotating balls, electrowetting material, cholesteric liquid crystal, other bistable material, or multi-stable material, for example. Herein, the non-volatile type display material M is instanced as electrophoretic material, such as a plurality of charged particles C disposed in a dielectric solution L. In this embodiment, the non-volatile type display apparatus 1 further includes a containing structure S, which can include a plurality of microcups or microcapsules for example. Herein, the containing structure S includes a plurality of microcups as an example. The charged particles C are disposed in the dielectric solution L, and both of them are disposed in the microcups.

In this embodiment, the non-volatile type display apparatus 1 further includes a common electrode layer 15, which is a transparent electrode layer and disposed between the non-volatile type display material M and the top substrate 14 and opposite to pixel electrodes 21 of the driving substrate 20. When a voltage difference is applied between the common electrode layer 15 and at least one of the pixel electrodes 21, the corresponding charged particles C are driven to move to allow the reflective light to show the color of the charged particles C or dielectric solution L. The material of the common electrode layer 15 can be, for example, ITO, IZO, AZO, GZO, ZnO, or the like.

Moreover, the non-volatile type display apparatus 1 can further include an adhesion layer 17, which can adhere to the driving substrate 20 and the containing structure S containing the non-volatile type display material M.

The control unit 12 is an integrated circuit, and disposed on the driving substrate 20 and electrically connected to the control circuit 23. The control unit 12 and the control circuit 23 are disposed on the same circuit board. However, the invention is not limited thereto. In other embodiments, the control unit 12 can include a plurality of integrated circuits, and may not be disposed on the driving substrate 20. The integrated circuit is disposed on the driving substrate 20 by wire bonding or flip-chip bonding, for example. Although the communication unit 11 is not shown in the figure, it can be disposed on the driving substrate 20 along with the control unit 12. Of course, in other embodiments, the communication unit 11 may not be disposed along with the control unit 12. No matter what kind of the disposition is, the communication unit 11 and the control unit 12 are just electrically connected to each other.

In this embodiment, the display unit 13 can further include at least a conductive body 32. The conductive body 32 is electrically connected to the control unit 12, and at least partially formed on the driving substrate 20 and disposed around or inside the display area D. Herein, the display area D is defined as the display area corresponding to the effective pixels, and the conductive body 32 is disposed around the display area D as an example.

In this embodiment, two ends of the conductive body 32 are connected to the control unit 12 so that the conductive body 32 is formed into a closed curve (such as an O-shaped or □-shaped curve) around the display area D. Herein, the conductive body 32 is a conductive wire disposed into a single strand, and the total length of the conductive body 32 is larger than or equal to three fourths of the perimeter of the display area D. When the displayed frame is renewed, the detection can be performed. While the driving substrate 20 is broken, the conductive body 32 is broken somewhere accordingly. Hence, in this case, when the control unit 12 transmits a detection signal to the conductive body 32, the control unit 12 can not receive the returned detection signal, and therefore the driving substrate 20 is ascertained as damaged. In other embodiments, the detection can be performed at other times. For example, it can be performed periodically, and the period can be adjusted according to the customer's requirement.

In the above, the form, location and number of the conductive body 32 and the location of the control unit 12 are just for example, but not for limiting the scope of the invention. Some varieties of the conductive body 32 and the control unit 12 are illustrated as below for example.

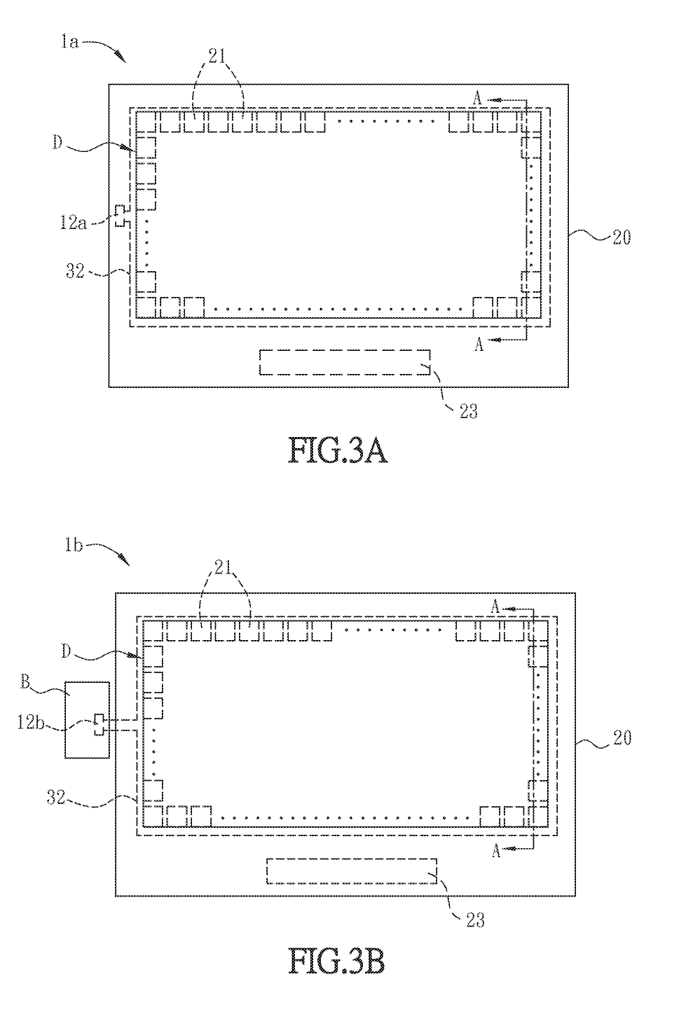

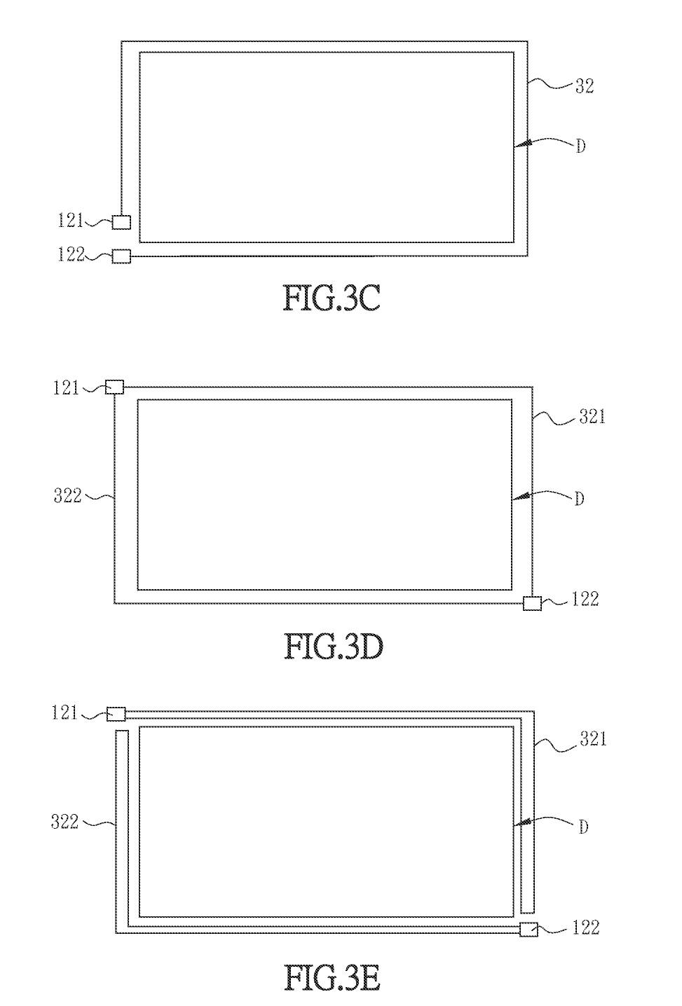

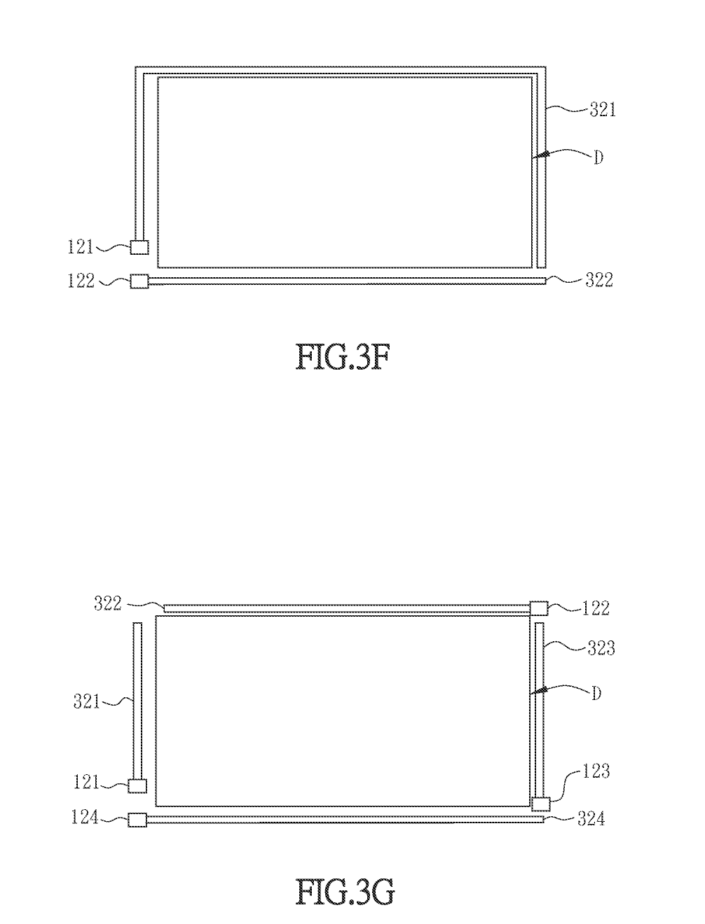

As shown in FIG. 3A, the control unit 12a of the non-volatile type display apparatus 1a is not disposed in the control circuit 23 of the driving substrate 20, but disposed on a side around the display area D. Besides, two ends of the conductive body 32 are connected to the control unit 12a so that the conductive body 32 is formed into a closed curve (like “O” or “□” shape) around the display area D.

As shown in FIG. 3B, the control unit 12b of the non-volatile type display apparatus 1b is disposed on another circuit board B, which can be disposed adjacent to the driving substrate 20. The control unit 12b is an integrated circuit, and can be disposed on the circuit board B by wire bonding or flip-chip bonding for example.

Some varieties of the non-volatile type display apparatus of the invention are further illustrated as below. For the sake of clear illustration, the figures show the display area D, the control unit, and the conductive body only. Besides, the control unit can be disposed on at least one of the driving substrate and a circuit board, and since this technical feature has been clearly illustrated as above, it is not described here for concise purpose.

As shown in FIG. 3C, the control unit includes two integrated circuits 121 and 122. One end of the conductive body 32 is connected to an integrated circuit (IC) 121 while the other end is connected to the other integrated circuit 122. Herein, the conductive body 32 is a conductive wire disposed into a single strand, substantially shaped like “O”.

As shown in FIG. 3D, the control unit includes two integrated circuits 121 and 122. The conductive body includes two conductive wires 321 and 322, formed into a closed curve. Two ends of the conductive wire 321 are connected to the integrated circuits 121 and 122, respectively, and two ends of the conductive wire 322 are connected to the integrated circuits 121 and 122, respectively. Herein, each of the conductive wires 321 and 322 is disposed into a single strand and shaped like “L”. The detection signal transmitted by the integrated circuit 121 can be received by the integrated circuit 122, and the detection signal transmitted by the integrated circuit 122 can be received by the integrated circuit 121. Besides, the total length of the conductive wires 321 and 322 is larger than or equal to the three fourths of the perimeter of the display area D. Thereby, the better detection effectiveness can be obtained.

As shown in FIG. 3E, the control unit includes two integrated circuits 121 and 122. The conductive body includes two conductive wires 321 and 322. Two ends of the conductive wire 321 are connected to different terminals of the integrated circuit 121, and two ends of the conductive wire 322 are connected to different terminals of the integrated circuit 122. Herein, each of the conductive wires 321 and 322 is disposed into two strands and shaped like “L”.

As shown in FIG. 3F, the control unit includes two integrated circuits 121 and 122. The conductive body includes two conductive wires 321 and 322. Two ends of the conductive wire 321 are connected to different terminals of the integrated circuit 121, and two ends of the conductive wire 322 are connected to different terminals of the integrated circuit 122. Herein, each of the conductive wires 321 and 322 is disposed into two strands. The two-strand conductive wire 321 is shaped like “U” (including “ [symbol] ”), and the two-strand conductive wire 322 is shaped like a line.

As shown in FIG. 3G, the control unit includes four integrated circuits 121 to 124. The conductive body includes four conductive wires 321 to 324. Two ends of the conductive wire 321 are connected to different terminals of the integrated circuit 121, two ends of the conductive wire 322 are connected to different terminals of the integrated circuit 122, two ends of the conductive wire 323 are connected to different terminals of the integrated circuit 123, and two ends of the conductive wire 324 are connected to different terminals of the integrated circuit 124. Herein, each of the conductive wires 321 to 324 is disposed into two strands, and the two-strand conductive wires 321 to 324 each are shaped like a line. In other embodiments, the conductive wire can be disposed into multiple strands and shaped like an irregular form.

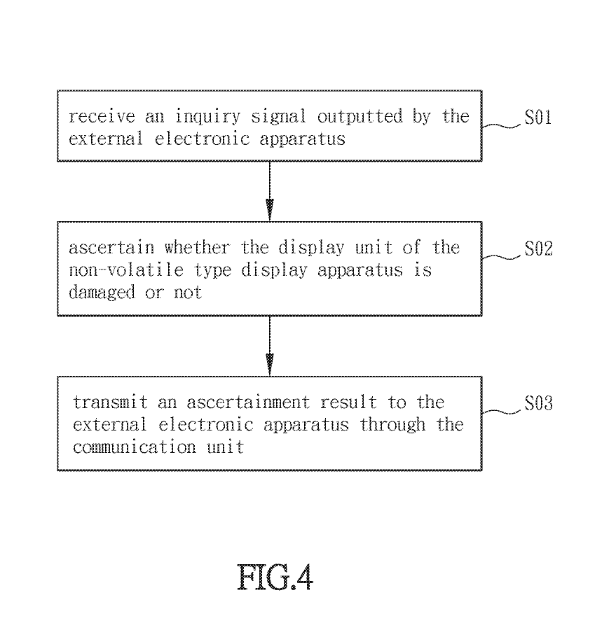

FIG. 4 is a flow chart of a damage detection method of a non-volatile type display apparatus according to a preferred embodiment of the invention. The damage detection method of this embodiment is cooperated with a non-volatile type display apparatus, and the following is the illustration taking the non-volatile type display apparatus 1 as an example, so the understanding will be facilitated by referring to FIG. 1. The non-volatile type display apparatus 1 is coupled to an external electronic apparatus 2, and since both of them are clearly illustrated in the above embodiments, they are not described here for concise purpose. The damage detection method includes the steps S01 and S02.

The step S01 is to receive an inquiry signal S1 outputted by the external electronic apparatus 2. In detail, the non-volatile type display apparatus 1 includes a communication unit 11, a control unit 12, and a display unit 13. The communication unit 11 can receive an inquiry signal S1 outputted by the external electronic apparatus 2, and then output an ascertainment signal S1 to the control unit 12.

The step S02 is to ascertain whether the display unit 13 of the non-volatile type display apparatus 1 is damaged or not. In detail, when receiving the ascertainment signal S2, the control unit 12 ascertains whether the display unit 13 is damaged or not.

The technical features of the communication unit 11, the control unit 12 and the display unit 13 can be understood by referring to the foregoing descriptions, and therefore they are not described here for concise purpose.

After the step S02, the step S03 is to transmit an ascertainment result made by the control unit 12 to the external electronic apparatus 2 through the communication unit 11, and thereby the manager can be informed whether the display unit 13 is damaged or not.

In this embodiment, the control unit 12 can ascertain whether the display unit 13 is damaged several times consecutively. If the ascertainment result indicates the damage at least one time, the display unit 13 is ascertained as damaged. Conversely, if all the ascertainment results indicate no damage, the display unit 13 is ascertained as undamaged. Thereby, the misjudgment rate about the condition of the display unit 13 can be decreased a lot.

In this embodiment, the inquiry signal S1 outputted by the external electronic apparatus 2 can be generated by the manager's operation to the external electronic apparatus 2, and in other words, the manager can self-determine the timing of the inquiry as the manual detection. Otherwise, the inquiry can be self-generated by the external electronic apparatus 2 periodically, such as three times a day, once per eight hours, etc., as the routine detection. Of course, the manual detection and the routine detection can be performed together. Besides, when the temperature, electric energy, vibration or their any combination of the non-volatile type display apparatus 1 is abnormal, the external electronic apparatus 2 can self-start the inquiry so as to discover the damage condition as soon as possible.

In this embodiment, the control unit 12 can output a detection signal to a conductive body of the display unit disposed around or inside a display area of the display unit, and then ascertain whether the display unit is damaged according to the return condition of the detection signal. In detail, if the control unit 12 receives the detection signal returned by the display unit 13, the display unit 13 is ascertained as undamaged. Conversely, if the control unit 12 doesn't receive the detection signal returned by the display unit 13, the display unit 13 is ascertained as damaged.

In summary, for the non-volatile type display apparatus and the damage detection method thereof according to the invention, when the external electronic apparatus queries the damage condition of the non-volatile type display apparatus, the display unit's condition cab be ascertained by the cooperation of the communication unit and the control unit, and then the ascertainment result can be transmitted to the manager so that the manager can find out the non-volatile type display apparatus has been damaged as soon as possible for the repair or the replacement.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A non-volatile type display apparatus, comprising:
a control unit; and
a display unit electrically connected to the control unit, wherein the control unit ascertains whether the display unit is damaged or not according to an ascertainment signal.

2. The non-volatile type display apparatus as recited in claim 1, cooperated with an external electronic apparatus and further comprising:
a communication unit coupled to the external electronic apparatus and the control unit, receiving an inquiry signal outputted by the external electronic apparatus and outputting the ascertainment signal to the control unit according to the inquiry signal.

3. The non-volatile type display apparatus as recited in claim 2, wherein the communication unit and the external electronic apparatus are coupled by a wired method or a wireless method.

4. The non-volatile type display apparatus as recited in claim 1, wherein the control unit includes a sensor, which senses temperature, electric energy, vibration, or their any combination,

5. The non-volatile type display apparatus as recited in claim 1, wherein the ascertainment signal is a periodic signal generated by the control unit, and the control unit outputs a detection signal, according to the ascertainment signal, to the display unit to ascertain whether the display unit is damaged.

6. The non-volatile type display apparatus as recited in claim 1, wherein the display unit further includes at least a conductive body, which is disposed around or inside a display area of the display unit and electrically connected to the control unit.

7. The non-volatile type display apparatus as recited in claim 6, wherein the control unit outputs a detection signal to the conductive body, and ascertains if the display unit is damaged according to whether the detection signal is returned or not.

8. The non-volatile type display apparatus as recited in claim 6, wherein the conductive body is a conductive wire disposed into a single strand or a plurality of strands.

9. The non-volatile type display apparatus as recited in claim 6, wherein the conductive body has a linear, “L”, “U”, or “O” shape.

10. The non-volatile type display apparatus as recited in claim 6, wherein the total length of the conductive body or the conductive bodies is larger than or equal to three fourths of the perimeter of a display area of the non-volatile type display apparatus.

11. The non-volatile type display apparatus as recited in claim 6, wherein the control unit includes a plurality of integrated circuits, and the conductive body is connected to the integrated circuits.

12. The non-volatile type display apparatus as recited in claim 6, wherein the display unit further includes a driving substrate, and the control unit is disposed on at least one of the driving substrate and a circuit board.

13. The non-volatile type display apparatus as recited in claim 12, wherein the circuit board is disposed adjacent to the driving substrate.

14. A damage detection method of a non-volatile type display apparatus, cooperated with a non-volatile type display apparatus coupled to an external electronic apparatus, and comprising steps of:
receiving an inquiry signal outputted by the external electronic apparatus; and
ascertaining whether a display unit of the non-volatile type display apparatus is damaged or not.

15. The damage detection method as recited in claim 14, wherein the non-volatile type display apparatus further includes a communication unit and a control unit, the communication unit, the control unit and the display unit are electrically connected to each other, when receiving the inquiry signal, the communication unit outputs an ascertainment signal to the control unit, and the control unit ascertains whether the display unit is damaged according to the ascertainment signal.

16. The damage detection method as recited in claim 14, wherein ascertaining whether the display unit is damaged is performed several times consecutively, and if the ascertainment result indicates the damage at least one time, the display unit is ascertained as damaged.

17. The damage detection method as recited in claim 14, wherein the inquiry signal outputted by the external electronic apparatus is generated by an operator operating the external electronic apparatus or self-generated by the external electronic apparatus.

18. The damage detection method as recited in claim 14, further comprising a step of:
transmitting an ascertainment result to the external electronic apparatus.

19. The damage detection method as recited in claim 15, wherein the control unit outputs a detection signal to a conductive body of the display unit disposed around or inside a display area of the display unit, and ascertains if the display unit is damaged according to whether the detection signal is returned or not.

20. The damage detection method as recited in claim 14, wherein when the temperature, electric energy, vibration or their any combination of the non-volatile type display apparatus is abnormal, the external electronic apparatus outputs the inquiry signal.
